(19) United States
(12) Patent Application Publication
(10) Pub. No.: US 2007/0279422 A1
(43) Pub. Date: Dec. 6, 2007

(54) Processor system including processors and data transfer method thereof

(76) Inventors: Hiroaki Sugita, Ome-shi (JP); Ryuji Sakai, Hanno-shi (JP)

Correspondence Address: SPRINKLE IP LAW GROUP, 1301 W. 25TH STREET, SUITE 408, AUSTIN, TX, 78705, US

(21) Appl. No.: 11/789,009

(22) Filed: Apr. 23, 2007

(30) Foreign Application Priority Data
Apr. 24, 2006 (JP) 2006-119613

(51) Int. Cl. G06F 15/16

(52) U.S. Cl. 345/502

(57) ABSTRACT

A processor system includes a plurality of first processors, a second processor, and a memory device. The first processors execute image processing on first image data to generate second image data. Each of the first processors processes the first image data in pixel group units. The memory device holds luminance components of at least one of the first image data and the second image data, in a first memory space with consecutive addresses. The memory device also holds the luminance components contained in the same pixel group, in the first memory space at the consecutive addresses.

### CROSS-REFERENCE TO RELATED APPLICATIONS

This application is based upon and claims the benefit of priority from prior Japanese Patent Application No. 2006-119613, filed Apr. 24, 2006, the entire contents of which are incorporated herein by reference.

### BACKGROUND OF THE INVENTION

1. Field of the Invention

The present invention relates to a processor system including a plurality of processors and a data transfer method for the processor system. For example, the present invention relates to a data transfer method for transferring data between a processor and a main memory in a processor system having a plurality of processors that share the main memory.

2. Description of the Related Art

In recent years, a processor system has been known which includes a main processor and a plurality of coprocessors operate depending on the main processor. Such a system has a known configuration which processes each certain set of pixels to decode image data and which allows the main memory to hold the luminance and color difference components of image data for that set of pixels. Such a configuration is disclosed in, for example, Jpn. Pat. Appln. KOKAI Publication No. 2006-65864 and Jpn. Pat. Appln. KOKAI Publication No. 2006-67247.

However, this conventional system may result in wasteful data during data transfer, reducing data transfer efficiency.

### BRIEF SUMMARY OF THE INVENTION

A processor system according to an aspect of the present invention includes:

a plurality of first processors which execute image processing on first image data to generate second image data, each of the first processors executing the image processing in pixel group units each of which is a set of a plurality of pixels contained in the first image data;

a second processor which controls an operation of the first processors; and

a memory device which holds at least one of the first image data and the second image data, the memory device holding luminance components of at least one of the first image data and the second image data in a first memory space with consecutive addresses and holding the luminance components contained in the same pixel group, in the first memory space at the consecutive addresses.

According to an aspect of the present invention, a data transfer method for a processor system including a main memory which holds image data containing a plurality of pixel groups each of which is a set of a plurality of pixels, a plurality of first processors each including a local memory, and a second processor which controls operations of a plurality of the first processors includes:

transferring luminance components obtained by the first processors by decoding the image data in the pixel group units, from the local memory to the main memory;

transferring color difference components obtained by the first processors by decoding the image data in the pixel group units, from the local memory to the main memory so that the color difference components are stored in an area of the main memory which is separate from an area of the main memory in which the luminance components are stored, the luminance components of the image data being held in the main memory at consecutive addresses, the luminance components contained in each of the pixel groups being held in the main memory at consecutive addresses.

### BRIEF DESCRIPTION OF THE SEVERAL VIEWS OF THE DRAWING

FIG. 1 is a block diagram of a computer system in accordance with a first embodiment of the present invention;

FIG. 2 is a conceptual diagram of a program executed by the computer system in accordance with the first embodiment of the present invention;

FIG. 3 is a timing chart of the program executed by the computer system in accordance with the first embodiment of the present invention;

FIG. 4 is a schematic diagram of a frame processed by the computer system in accordance with the first embodiment of the present invention;

FIG. 5 is a schematic diagram of the frame processed by the computer system in accordance with the first embodiment of the present invention, the diagram showing luminance components;

FIG. 6 is a schematic diagram of the frame processed by the computer system in accordance with the first embodiment of the present invention, the diagram showing color difference components;

FIG. 7 is a schematic diagram of the frame processed by the computer system in accordance with the first embodiment of the present invention, the diagram showing color difference components;

FIG. 8 is a schematic diagram of the frame processed by the computer system in accordance with the first embodiment of the present invention, the diagram showing macro blocks;

FIG. 9 is a schematic diagram of the frame processed by the computer system in accordance with the first embodiment of the present invention, the diagram showing the luminance components of one macro block;

FIG. 10 is a schematic diagram of the frame processed by the computer system in accordance with the first embodiment of the present invention, the diagram showing the color difference components of one macro block;

FIG. 11 is a schematic diagram of the frame processed by the computer system in accordance with the first embodiment of the present invention, the diagram showing the luminance components of one macro block;

FIG. 12 is a schematic diagram of the frame processed by the computer system in accordance with the first embodiment of the present invention, the diagram showing the color difference components of one macro block;

FIG. 13 is a conceptual diagram of memory spaces in a main memory provided in the computer system in accordance with the first embodiment of the present invention, the drawing showing how macro blocks are stored;

FIG. 14 is a conceptual diagram of memory spaces in a main memory provided in the computer system in accordance with the first embodiment of the present invention, the drawing showing how luminance components are stored;

FIG. 15 is a conceptual diagram of memory spaces in a main memory provided in the computer system in accordance with the first embodiment of the present invention, the drawing showing how color difference components are stored;

FIG. 16 is a schematic diagram of a frame processed by the computer system in accordance with the first embodiment of the present invention, the diagram showing how raster scanning is performed on luminance components;

FIG. 17 is a schematic diagram of a frame processed by the computer system in accordance with the first embodiment of the present invention, the diagram showing how raster scanning is performed on color difference components;

FIG. 18 is a schematic diagram of a frame showing conventional raster scanning;

FIG. 19 is a schematic diagram of a frame showing a conventional manner of reading data stored in order of raster scans;

FIG. 20 is a schematic diagram of a frame processed by the computer system in accordance with the first embodiment of the present invention, the diagram showing how data is read from the main memory;

FIG. 21 is a schematic diagram of the frame processed by the computer system in accordance with the first embodiment of the present invention, the diagram showing how data is read from the main memory;

FIG. 22 is a conceptual diagram of a program executed by a computer system in accordance with a second embodiment of the present invention;

FIG. 23 is a timing chart of the program executed by the computer system in accordance with the second embodiment of the present invention;

FIG. 24 is a conceptual diagram of memory spaces in a main memory provided in the computer system in accordance with the second embodiment of the present invention, the drawing showing how macro blocks are stored;

FIG. 25 is a conceptual diagram of the memory space in the main memory provided in the computer system in accordance with the second embodiment of the present invention, the drawing showing how luminance components are stored;

FIG. 26 is a conceptual diagram of the memory space in the main memory provided in the computer system in accordance with the second embodiment of the present invention, the drawing showing how color difference components are stored;

FIG. 27 is a schematic diagram of a frame processed by the computer system in accordance with the second embodiment of the present invention, the diagram showing how raster scanning is performed on luminance components;

FIG. 28 is a schematic diagram of the frame processed by the computer system in accordance with the second embodiment of the present invention, the diagram showing how raster scanning is performed on color difference components;

FIG. 29 is a schematic diagram of frames processed by the computer systems in accordance with the first and second embodiments of the present invention, the diagram showing a motion vector;

FIG. 30 is a flowchart of a data transfer method for the computer systems in accordance with the first and second embodiments of the present invention;

FIG. 31 is a schematic diagram showing memory spaces in the main memory provided in the computer systems in accordance with the first and second embodiments of the present invention as well as a frame, the drawing showing how data in macro blocks in first rows is stored in the main memory; and

FIG. 32 is a schematic diagram showing the memory space in the main memory provided in the computer systems in accordance with the first and second embodiments of the present invention as well as the frame, the drawing showing how data in macro blocks in second rows is stored in the main memory.

### DETAILED DESCRIPTION OF THE INVENTION

### First Embodiment

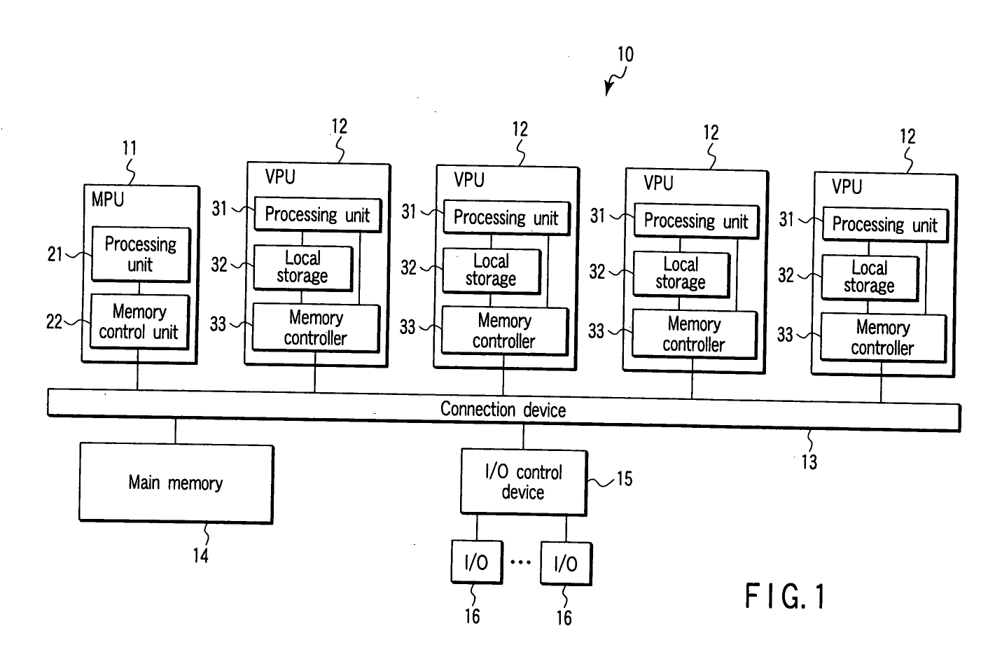

With reference to FIG. 1, description will be given of a processor system and a data transfer method in accordance with a first embodiment of the present invention. FIG. 1 is a block diagram of a computer system in accordance with the first embodiment. The computer system in accordance with the first embodiment is a digital video processing system comprising an input and an output for videos. The computer system in accordance with the first embodiment can be utilized not only as a general purpose computer but also as a built-in system for various types of electronic equipment.

As shown in the figure, the computer system 10 includes a master processor unit (MPU) 11, a plurality of versatile processor units (VPU) 12, a connection device 13, a main memory 14, an I/O control device 15, and an I/O device 16.

MPU 11 is a main processor that controls the operation of the computer system 10. An operating system (OS) is executed mainly by MPU 11. The performance of some functions of OS may be shared by VPUs 12 and the I/O device 15.

Each VPUs 12 are processors that execute various processes under the control of MPU 11. MPU 11 performs control such that a process can be distributed among the plurality of VPUs 12 for parallel execution. This enables the process to be efficiently executed at a high speed.

The main memory 14 is a storage device (shared memory) shared by MPU 11, the plurality of VPUs 12, and the I/O device 15. The maim memory 14 holds OS, application programs, and video data input by the I/O control device 15.

The I/O control device 15 connects to one or more I/O devices 16. The I/O control device 15 is also called a bridge. The I/O control device 15 controls the operation of the I/O device 16.

The connection device 13 connects together MPU 11, VPU 12, the main memory 14, and the I/O device 15, described above.

The configuration illustrated in FIG. 1 includes one MPU 11, four VPUs 12, one memory 14, and one I/O control device. However, the numbers of these circuit blocks including VPUs 12 are not limited. Alternatively, a plurality of MPUs 11 may be provided or MPU 11 may be omitted. Without MPU 11, the processes otherwise executed by MPU 11 are executed any of VPUs 12. That is, VPU also virtually serves as MPU 11.

Now, the configuration of MPU 11 and VPU 12 will be described with reference to FIG. 1.

MPU 11 includes a processing unit 21 and a memory control unit 22. The memory control unit 22 includes a cache memory. The memory control unit reads data from the main memory 14 into the cache memory, writes data from the cache memory to the main memory 14, and controls virtual storage. The processing unit 21 uses data held in the cache memory of the memory control unit 22 to execute processing.

VPU 22 includes a processing unit 31, a local storage (local memory) 32, and a memory controller 33. The local storage 32 is a memory device that can hold data. The memory controller 33 functions as a DMA controller that transfers data between the local storage 32 and the main memory 14 by direct memory access (DMA) transfer. The memory controller 33 has a virtual storage control function similar to that of the memory control unit 22 in MPU 11.

The processing unit 31 of each VPU 12 can directly access the local storage 32 inside that VPU 12. The processing unit 31 uses the local storage 32 as a main memory. That is, the processing unit 31 gives instructions to the memory controller 33 instead of directly accessing the main memory 14. Thus, the processing unit 31 transfers contents of the main memory 14 to the local storage to read the contents from the local storage, and transfers contents of the local storage 32 to the main memory 14 to write the contents to the main memory 14.

For convenience of hardware implementation, the data transfer by DMA is performed in 128-byte units or an integral multiple of 128-byte units. For example, when 1-byte data is transferred from the main memory 14 to the local storage 32 in a certain VPU 12, the data is transferred to that VPU 12 as follows. The addresses in the main memory 14 are divided into sections with 128 bytes, starting with the leading address. The memory controller 33 in VPU 12 reads data from the 128-byte section in which the relevant data is present. The memory controller 33 takes the required 1 byte out of the read 128 bytes and stores that byte in the local storage 32. Further, when 2-byte or more data is transferred and if the data to be transferred spans a plurality of 128-byte sections, all the sections spanned by the data are transferred to the memory controller 33.

MPU 11 controls each VPU 12 using a hardware mechanism such as a control register. Control performed by VPU 12 includes, for example, reading and writing data from and to the register provided in VPU 12 and starting and stopping the execution of a program by VPU 12. Further, communication and synchronization between MPU 11 and VPU 12 or between VPUs 12 are performed by a hardware mechanism such as a mail box or an event flag.

The operation of the computer system 10 configured as described above will be described taking the case where MPEG (Moving Picture Experts Group)-2 format videos input through the I/O device 16 are converted into an H.264 format. MPEG-2 and H.264 are the names of standards according to which videos are compressively encoded. Of course, this conversion process is only an example of processes executed by the computer system 10.

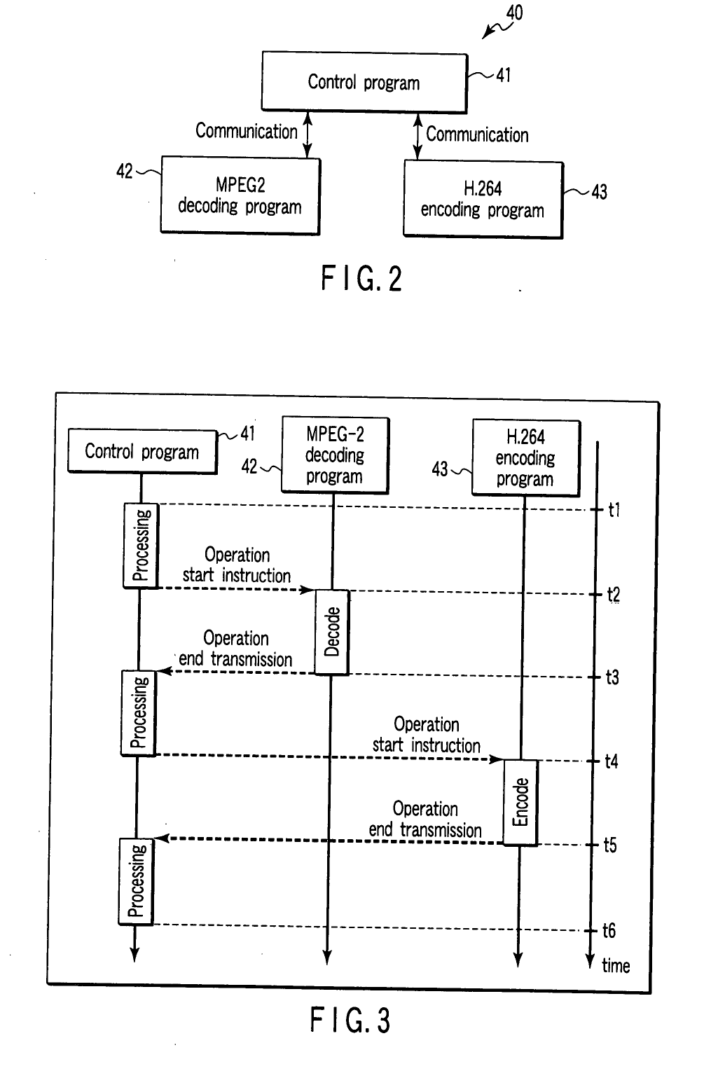

FIG. 2 shows the configuration of a program used to implement the conversion system. FIG. 2 is a conceptual diagram showing the configuration of a program that converts MPEG-2 into H.264. As shown in the figure, a program 40 includes a control program 41, an MPEG-2 decoding program 42, and an H.264 encoding program 43. The control program 41 operates on MPU 11. The MPEG-2 decoding program 42 and the H.264 encoding program 43 operate on one or more VPUs 12. The MPEG-2 decoding program 42 decodes video data compressively encoded into the MPEG-2 format to obtain videos. The H.264 encoding program 43 compressively encodes the videos resulting from decoding into the H.264 format.

FIG. 3 is a timing chart showing the flow of processing executed by the control program 41, the MPEG-2 decoding program 42, and the H.264 encoding program 43. In the figure, time flows from the top to bottom of the sheet of the drawing.

First, at a time t1, for example, MPU 11 executes the control program 41. On the basis of the control program 41, MPU 11 reads video data encoded into the MPEG-2 format, from the I/O control device 15 via the connection device 13. MPU 11 then divides the read video data into frames of data and then stores the frames in the main memory 14. The frame refers to a single image constituting the video data and corresponding to each time period.

Then, at a time t2, MPU 11 instructs the MPEG-2 decoding program 42 to be executed, on the basis of the control program 41. The MPEG-2 decoding program 42 is executed by, for example, each VPU 12. Then, on the basis of the MPEG-2 decoding program 42, the memory controller 33 in VPU 12 reads data from the main memory 14 into the local storage 32 by DMA. Then, the processing unit 31 decodes the data read into the local storage 32 and stores decoding results in the local storage 32. Subsequently, the memory controller 33 writes the decoding results from the local storage 32 to the main memory 14 by DMA.

In this case, the memory capacity of the local storage 32 is smaller than the data size of one frame. That is, the local storage 32 cannot hold all of one frame of data. Consequently, the MPEG-2 data is partly read from the main memory 14 into the local storage 32. The image decoding results are partly transferred from the local storage 32 to the main memory 14. This process is repeated to decode one frame of data. Once one frame of MPEG-2 data is decoded, the MPEG-2 decoding program 42 transmits information indicating that decoding has been finished, to the control program 41.

At a time t3, MPU 11 receives the information indicating that decoding has been finished, from the MPEG-2 decoding program 42. At a time t4, MPU 11 instructs the H.264 encoding program 43 to be executed, on the basis of the control program 41. The H.264 encoding program 43 is executed by, for example, each VPU 12.

On the basis of the H.264 encoding program 43, the memory controller 33 in VPU 12 reads the MPEG-2 decoding results from the main memory 14 into the local storage 32. The processing unit 31 encodes the decoding results into the H.264 format and stores the encoding results in the local storage 32. The memory controller 33 subsequently transfers the encoding results from the local storage 32 to the main memory 14 using DMA. At this time, since the local storage cannot hold all of one frame of information as is the case with decoding, both input and output information are subjected to DMA in small units to execute an H.264 encoding process.

At a time t5, once the encoding process is finished, VPU 12 transmits information indicating that encoding has been finished, to MPU 11 on the basis of the H.264 encoding program 43. MPU 11 receives the information indicating that encoding has been finished. Then, on the basis of the control program 41, MPU 11 outputs the results of encoding by the H.264 encoding program 43 from the main memory 14 to the I/O device 16 via the I/O control device 15.

The data transmitted to MPU 11, executing the control program 41, by VPU 12, executing the MPEG-2 decoding program, may include data obtained during the MPEG-2 format decoding process as additional information. In this case, VPU 12 can utilize the additional information to execute the H.264 encoding program 43. This enables H.264 format encoding process to be executed at a high speed.

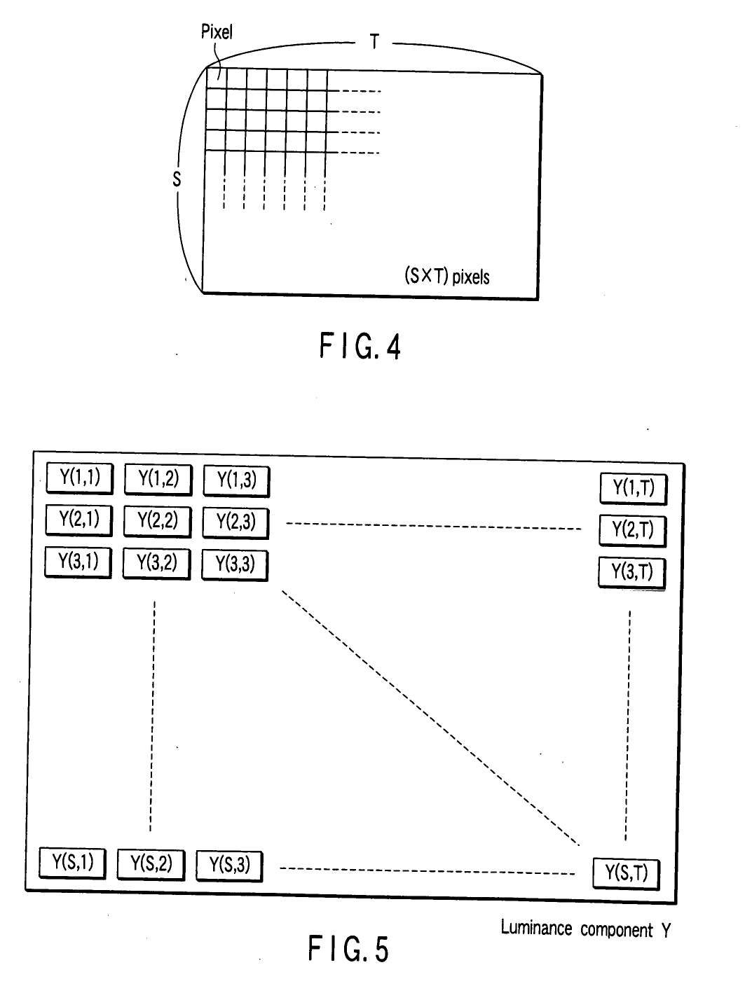

Now, a detailed description will be given of how video data (frame image data) resulting from decoding is stored in the main memory in the computer system 10. FIG. 4 is a schematic diagram showing one frame resulting from decoding. As shown in the figure, one frame is drawn with a set of (S×T) (S and T are natural numbers) pixels. For example, S=480 and T=720.

Frame image data is handled as luminance components Y, color difference components U, and color difference components V. FIG. 5 is a schematic diagram of one frame specifically showing the luminance components Y. The luminance component Y is data provided for each pixel and is information on the luminance of the pixel. The luminance component Y is hereinafter sometimes referred to as Y (i, j). Reference character i denotes a vertical position in the frame and has any of the values ranging from 1 at the top of the frame to S at the bottom of the frame. Reference character j denotes a horizontal position in the frame and has any of the values ranging from 1 at the left end of the frame to T at the right end of the frame. Accordingly, the uppermost leftmost luminance component Y in the frame is Y (1, 1), and the lowermost rightmost luminance component Y in the frame is Y (S, T).

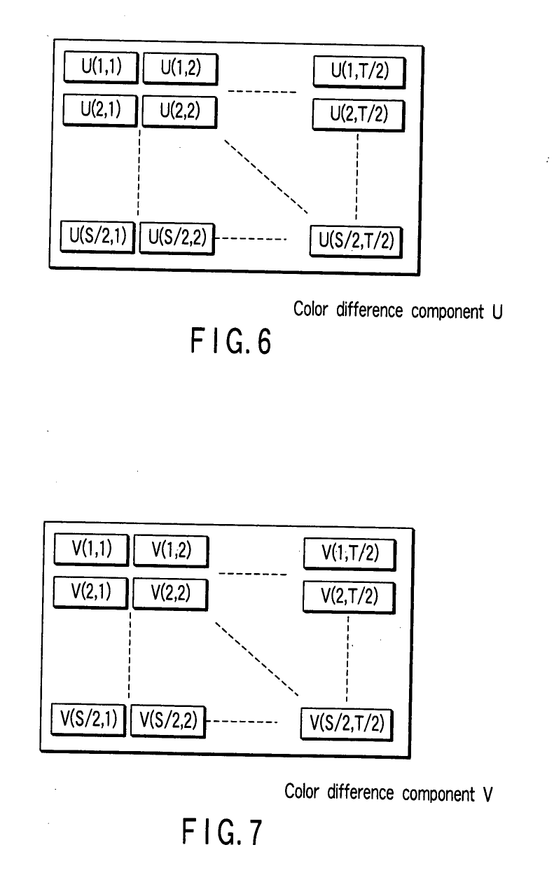

The color difference components U and V are information on colors. The color difference component U is information indicating the difference between a red component and a green component contained in adjacent pixels. The color difference component V is information indicating the difference between a blue component and a green component contained in adjacent pixels. That is, the color difference components U and V indicate the differences in color among the adjacent four pixels. Accordingly, the number of the color difference components U and V is one-fourth of the total number of the luminance components Y. FIGS. 6 and 7 are schematic diagrams of one frame showing the color difference components U and V. The color difference component U is hereinafter sometimes referred to as U (k, l). Reference character k denotes a vertical position in the frame and has any of the values ranging from 1 at the top of the frame to (S/2) at the bottom of the frame. Reference character l denotes a horizontal position in the frame and has any of the values ranging from 1 at the left end of the frame to (T/2) at the right end of the frame. Accordingly, the uppermost leftmost color difference component U in the frame is U (1, 1), and the lowermost rightmost color difference component U in the frame is U (S/2, T/2). This also applies to the color difference component V. The number of luminance components Y in each of the vertical and horizontal directions is always a multiple of 16. This is because the MPEG-2 decoding process is executed in (16×16)-pixel units for the luminance component Y and in (8×8)-pixel units for the color difference components U and V. These units are hereinafter referred to as macro blocks MB. The amount of data in each of the luminance component Y and the color difference components U and V is 1 byte. Accordingly, the total amount of data in the luminance components Y contained in each macro block MB is 256 bytes.

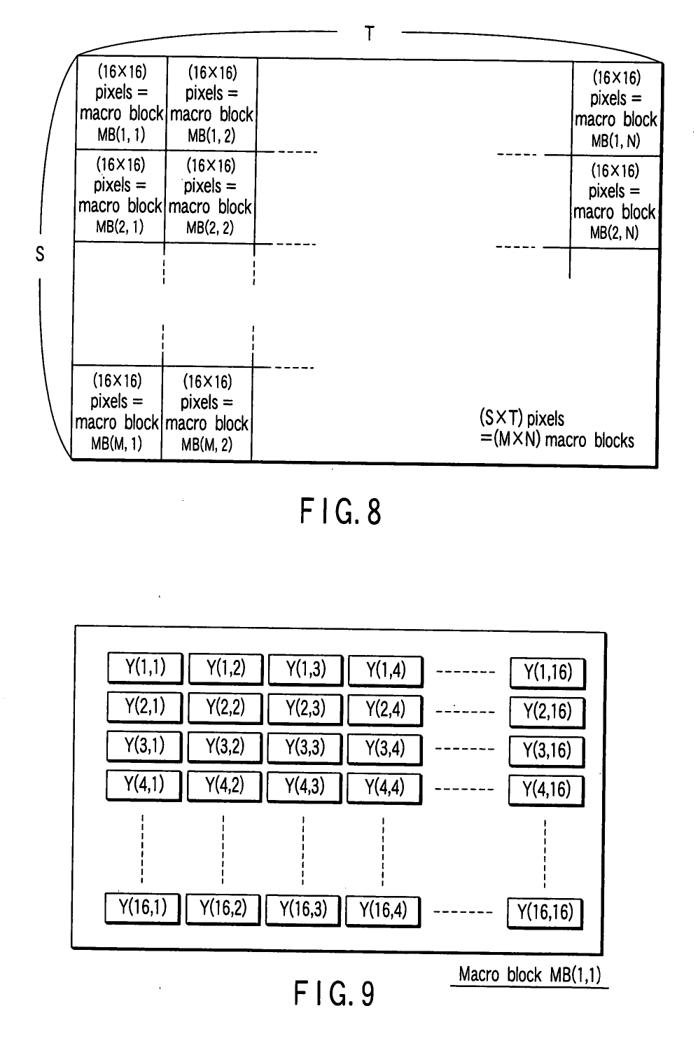

Macro blocks will be described with reference to FIG. 8. FIG. 8 is a schematic diagram of one frame showing macro blocks. As shown in the figure, one frame contains (M×N) macro blocks. Each macro block MB contains (16×16) pixels. The macro block is hereinafter referred to as MB (m, n). Reference character m denotes a vertical position in the frame and has any of the values ranging from 1 at the top of the frame to (S/16) at the bottom of the frame. Reference character n denotes a horizontal position in the frame and has any of the values ranging from 1 at the left end of the frame to (T/16) at the right end of the frame. Accordingly, the uppermost leftmost macro block MB is MB (1, 1), and the lowermost rightmost macro block MB is MB (M, N).

FIG. 9 is a schematic diagram of the macro block MB (1, 1) specifically showing the luminance component Y. As described above, one macro block MB contains (16×16) pixels. Accordingly, the number of the luminance components Y is also (16×16). The macro block contains Y (1, j) to Y (16, j) in the vertical direction, and Y (i, 1) to Y (i, 16) in the horizontal direction.

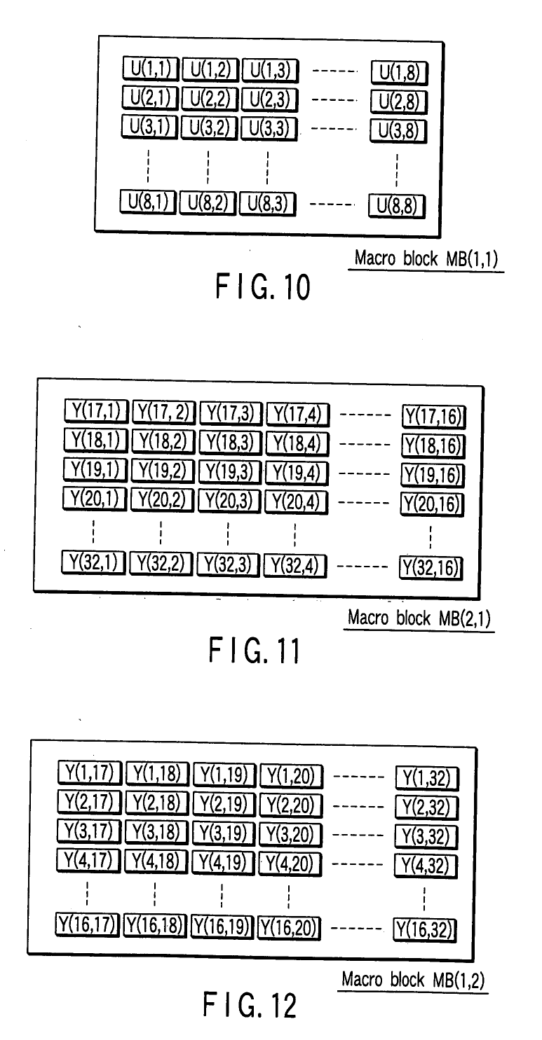

FIG. 10 is a schematic diagram of the macro blocks MB (1, 1) specifically showing the color difference components U. The number of the luminance components U is also (8×8). The macro block contains U (1, 1) to U (8, 1) in the vertical direction, and U (k, 1) to U (k, 8) in the horizontal direction. This also applies to the color difference components V.

FIG. 11 is a schematic diagram of the macro block MB (2, 1) adjacent to the macro block MB (1, 1) in the vertical direction, specifically showing the luminance components Y. The positions of the pixels contained in the macro blocks MB (1, 1) and MB (2, 1) are the same in the horizontal direction. Accordingly, the luminance components Y contained in the macro block MB (2, 1) are Y (17, j) to Y (32, j) in the vertical direction and Y (i, 1) to Y (i, 16) in the horizontal direction.

FIG. 12 is a schematic diagram of the macro block MB (1, 2) adjacent to the macro block MB (1, 1) in the horizontal direction, specifically showing the luminance components Y. The positions of the pixels contained in the macro blocks MB (1, 1) and MB (1, 2) are the same in the vertical direction. Accordingly, the luminance components Y contained in the macro block MB (1, 2) are Y (1, j) to Y (16, j) in the vertical direction and Y (i, 17) to Y (i, 32) in the horizontal direction.

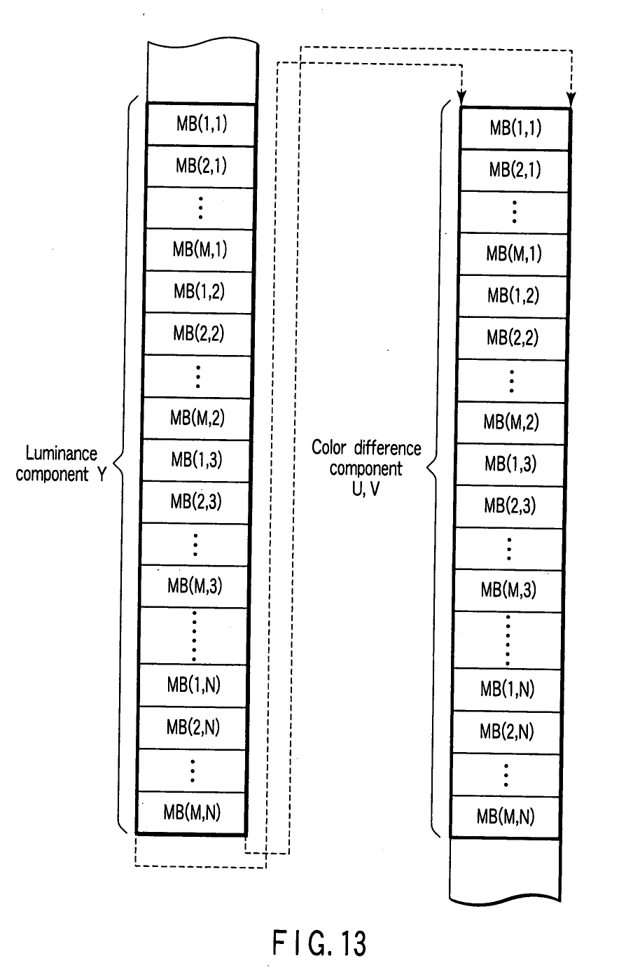

FIG. 13 is a schematic diagram of a memory space showing how VPU 12 stores frame image data resulting from decoding in the main memory 14.

As shown in the figure, the luminance components Y in each macro block MB are collectively arranged in the main memory 14 at consecutive addresses and followed by the color difference components U and V collectively arranged at consecutive addresses.

The luminance components Y and the color difference components U and V are sequentially stored in the main memory 14 in the vertical direction starting from the macro block (1, 1), located at the leftmost uppermost position of the frame. Once the components are stored down to the lowermost macro block (M, 1), the remaining components are stored in the macro block MB (1, 2) adjacent to the macro block MB (1, 1) in the horizontal direction. That is, the components are sequentially stored in the main memory 14 from the macro block MB (1, 1) to the macro block MB (M, 1), then in the main memory 14 from the macro block MB (1, 2) to the macro block MB (M, 2), and finally in the main memory 14 from the macro block MB (1, N) to the macro block MB (M, N).

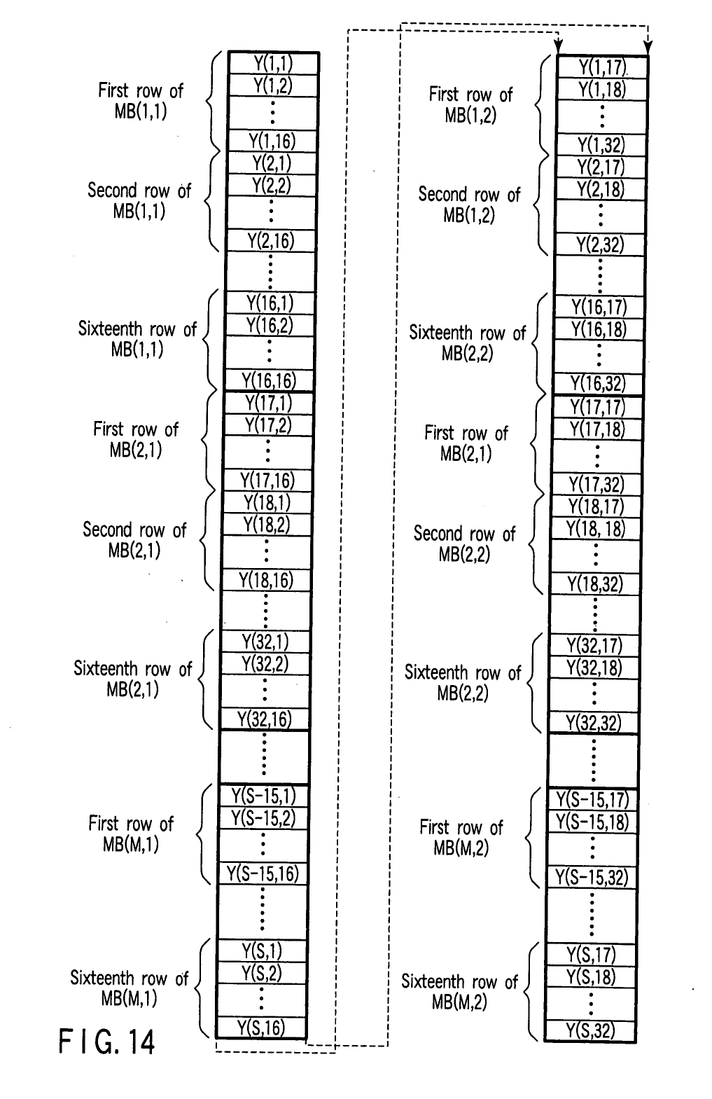

With reference to FIG. 14, description will be given of the arrangement, in the main memory 14, of the luminance components Y contained in each macro block MB. FIG. 14 is a schematic diagram of memory spaces in the main memory 14 showing an area in which the luminance components Y of the macro blocks MB (1, 1) to MB (M, 1) and MB (1, 2) to MB (M, 2) are held.

As shown in the figure, the luminance components Y (1, 1) to Y (1, 16) of the pixels in the first row in the macro block MB (1, 1) are first stored. The luminance components Y (2, 1) to Y (2, 16) of the pixels in the second row in the macro block MB (1, 1) are subsequently stored. The luminance components Y in the third to sixteenth rows are subsequently stored.

The luminance components Y (17, 1) to Y (17, 16) of the pixels in the first row in the macro block MB (2, 1) are then stored. The luminance components Y in the second to sixteenth rows are subsequently stored.

The luminance components Y of the macro blocks MB (1, 1) to MB (M, 1) are thus sequentially stored in the main memory 14. Then, the luminance components Y (1, 17) to Y (1, 32) of the pixels in the first row in the macro block MB (1, 2) are thus sequentially stored. The macro blocks MB (2, 2) to MB (M, 2), having the same coordinate on the axis of abscissa as that of the macro block MB (1, 2), are then sequentially stored.

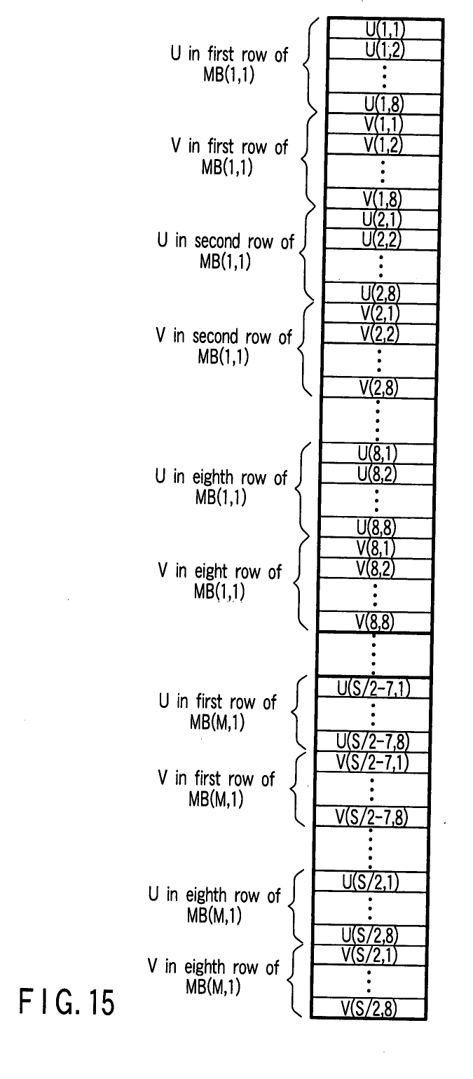

Now, with reference to FIG. 15, description will be given of the arrangement, in the main memory 14, of the color difference components U and V contained in each macro block MB. FIG. 15 is a schematic diagram of memory spaces in the main memory 14 showing an area in which the color difference components U and V of the macro blocks MB (1, 1) to MB (M, 1) are held.

As shown in the figure, the color difference components U (1, 1) to U (1, 8) of the pixels in the first row in the macro block MB (1, 1) are first sequentially stored. The color difference components V (1, 1) to V (1, 8) are then sequentially stored. The color difference components U (2, 1) to U (2, 8) of the pixels in the second row in the macro block MB (1, 1) are subsequently stored. The color difference components V (2, 1) to V (2, 8) are then stored. The luminance components U and V in the third to eight rows are subsequently stored.

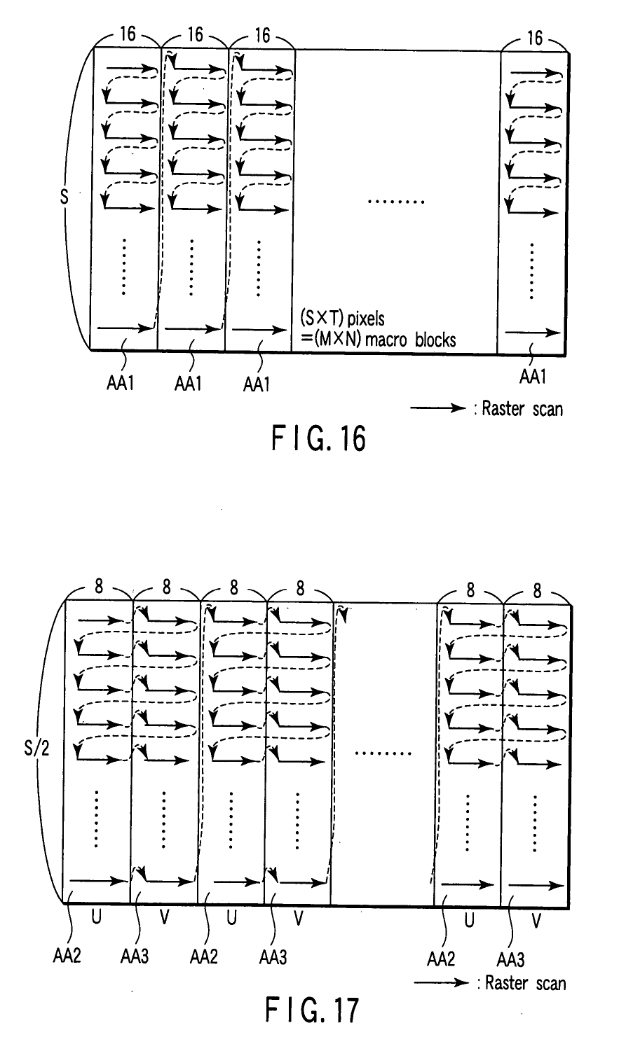

The above data memory arrangement will be described below on the basis of the arrangement of the luminance components in a frame. FIG. 16 is a schematic diagram of one frame specifically showing the luminance components Y. As shown in the figure, the frame is divided into a plurality of 16-byte rectangular areas AA1 having the same horizontal width as that of the macro block. In each area AA1, the luminance components are sequentially stored in the main memory 14 in the horizontal direction. That is, the luminance components are sequentially stored in the main memory 14 in the horizontal direction starting from the uppermost leftmost area. Once the storage of the luminance components reaches the end of that area, the luminance components in the next row are similarly stored in the main memory. All the luminance components in area AA1 are thus stored in the main memory 14. Then, the luminance components in adjacent AA1 in the horizontal direction are similarly stored in the main memory 14.

FIG. 17 shows the luminance components U and V. As shown in the figure, the frame is divided into a plurality of 8-byte rectangular areas AA2 (for the color difference components U) and a plurality of 8-byte rectangular areas AA3 (for the color difference components V) both having the same horizontal width as that of the macro block. In each of areas AA1 and AA2, the color difference components U are sequentially stored in the main memory 14 in the horizontal direction. That is, the color difference components U are sequentially stored in the main memory 14 rightward starting from the uppermost leftmost area in area AA1. Once the storage of the color difference components U is finished up to the end of area AA1, the color difference components V in area AA2 are similarly stored in the main memory 14 starting with the uppermost leftmost component V. Once the storage of the color difference components V is finished up to the end of area AA2, the color difference components U and V in the next rows are similarly stored in the main memory 14. All the color difference components U and V in areas AA1 and AA2 are thus stored in the main memory 14. Then, the color difference components U and V in adjacent areas AA1 and AA2 in the horizontal direction are similarly stored in the main memory 14.

As described above, the MPEG-2 format image data is stored in the main memory so as to separate the luminance components from the color difference components. Subsequently, each VPU 12 executes an H.264 format encoding process on the basis of the H.264 encoding program 43. That is, the image data stored so as to separate the luminance components from the color difference components is read from the main memory 14 and encoded into the H.264 format. The memory controller 33 then stores the encoding results provided by the processing unit 31 in the main memory 14.

As described above, the computer system in accordance with the first embodiment of the present invention can improve data transfer efficiency. This effect will be described below.

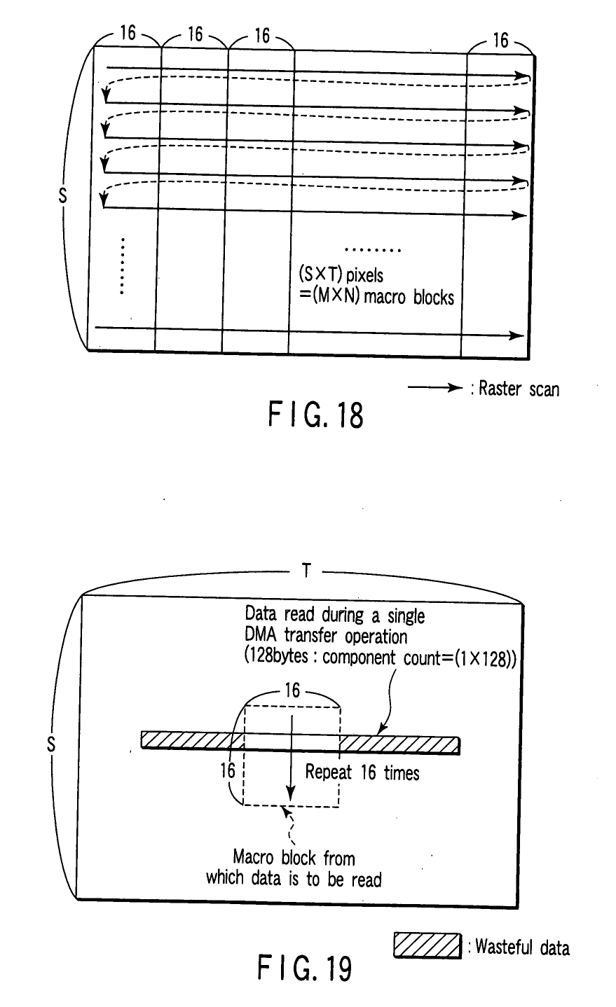

FIG. 18 is a schematic diagram of a frame showing how data is held in the main memory in order of raster scans. As shown in the figure, scanning is started from the uppermost leftmost position of the frame. The scanning is continuously performed up to the right end of the frame and then similarly on the next row. That is, the data is sequentially held in the main memory from the left end to right end of the frame. Accordingly, for T=720, there is a difference of 720 bytes between the addresses, in the main memory, of the luminance components of pixels located at the same horizontal position and adjacent to each other in the vertical direction.

FIG. 19 shows that the luminance components Y in one macro block are read from the main memory using the method for storing data in the memory as described above. FIG. 19 is a schematic diagram of a frame.

As described above, for DMA transfer, transfer data units are normally limited to have a fixed value, for example, 128 bytes. Thus, in order to read the luminance components Y in one macro block MB, the storage of data in the memory in order of raster scans needs to perform 16 DMA transfers to transfer a total of 2,048-byte data. The reason is as follows.

A single DMA transfer reads, from the main memory 14, 128-byte data with consecutive addresses in the main memory 14. Then, the above method holds one row of luminance components Y from the left end to right end of the frame, in the main memory at consecutive addresses. Accordingly, as shown in FIG. 19, even when data is transferred from the main memory to VPU with a single DMA transfer, the maximum required data is only 16 bytes. The remaining 112 bytes are unnecessary data. That is, the local memory in VPU can acquire only one row of data from the macro block MB with a single DMA transfer. Consequently, at least 16 DMA transfers are necessary to acquire 16 rows of data from the macro block MB. Then, since a single DMA transfer transfers 128 bytes of data, 128 bytes×16=2,048 byte-data must be transferred in order to transfer data in one macro block MB. That is, 2,048−128=1,920 byte-data is wastefully transferred.

This also applies not only to the luminous components Y but also to the color difference components U and V. In many cases, for the color difference components U and V, MPEG-2 and H.264 simultaneously utilize the macro block components at the same coordinates owing to the algorithms of MPEG-2 and H.264. Then, the arrangement in order of raster scans requires eight DMA transfers to transfer the color difference components U in one macro block from the main memory to the local storage. Likewise, the arrangement in order of raster scans requires eight DMA transfers to transfer the color difference components V in one macro block from the main memory to the local storage. Consequently, a total of 2,048-byte data needs to be transferred in order to acquire required 128-byte data. Thus, during DMA transfer, the existing technique transfers more data than required. This disadvantageously affects the band of a bus to reduce the speed at which the program is executed.

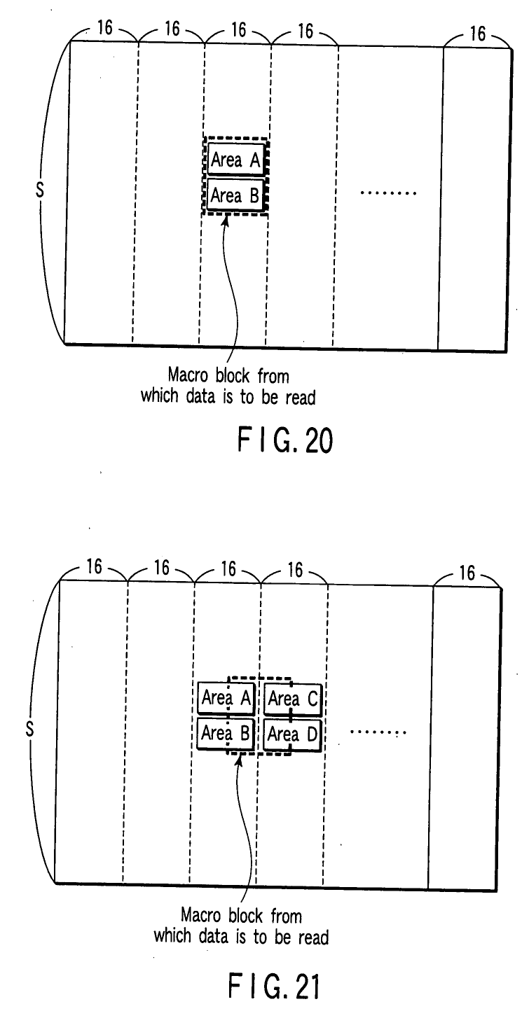

However, as described with reference to FIGS. 13 to 17, the configuration in accordance with the present embodiment stores the luminance components Y and the color difference components U in the main memory 14 so that the components in different macro blocks are stored in the respective rows. That is, the 256-byte data in one macro block is arranged in the main memory 14 at consecutive addresses. This improves the efficiency of DMA transfer of the components in one macro block from the main memory 14 to the local storage 32. This will be described with reference to FIG. 20. FIG. 20 is a schematic diagram of a frame showing how the luminance components Y in one macro block are read from the main memory.

As described above, the luminance components in the macro block MB are arranged in the main memory 14 at consecutive addresses. Accordingly, as shown in the figure, when components in one macro block are read from the main memory 14 into the local storage 32, the uppermost leftmost component in the macro block MB can be set to be a leading address in order to read data from an illustrated area A into the local storage 32 with a single DMA transfer. Further, the address following the final address in area A can be set to be a leading address in order to read data from an illustrated area B with a single DMA transfer. That is, while the conventional arrangement in order of raster scans requires 16 DMA transfers, the method in accordance with the first embodiment requires only two DMA transfers, enabling a reduction in the number of transfers to one-eighth. Moreover, the first embodiment makes it possible to avoid wasteful data transfers. That is, according to the first embodiment, all of the 256-byte data transferred during the two DMA is the required luminance components in the macro block MB. Consequently, compared to the conventional raster scanning, the amount of data passing through the connection device 13 is 256/2048=1/8. This enables a reduction in the amount of data transferred by DMA transfer, making it possible to inhibit the bandwidth of the bus from being occupied. This also applies to the color difference components U and V.

In the above description, DMA transfer is performed in 128-byte units. However, DMA transfer in 256-byte units requires only one DMA transfer because the data in areas A and B are stored in the main memory 14 at consecutive addresses.

FIG. 21 shows another example. FIG. 21 is a schematic diagram of a frame showing the case where (16×16) luminance components Y to be read span a plurality of macro blocks MB.

As shown in the figure, if the (16×16) luminance components Y span a plurality of macro blocks MB, the luminance components Y may be read from four areas A, B, C, and D each composed of 128 bytes. In this case, the amount of data transferred by DMA is 128 bytes×4=512 bytes. Of the transferred data, 256 bytes are useless but this amount is substantially smaller than that required for the conventional technique. That is, the first transfer operation may transfer the data from areas A and B, and the next transfer operation may transfer the data from areas C and D (DMA transfer in 256-byte units).

### Second Embodiment

Now, description will be given of a processor system and a data transfer method in accordance with a second embodiment of the present invention. The present embodiment relates to a method for storing image data in the main memory which method is different from that described in the first embodiment. The method will be described taking the case of a video conversion system that converts frame image data into the MPEG-2 format.

The configuration of the computer system in accordance with the present embodiment is the same as that shown in FIG. 1, described in the first embodiment. Therefore, description of the configuration of the system is omitted.

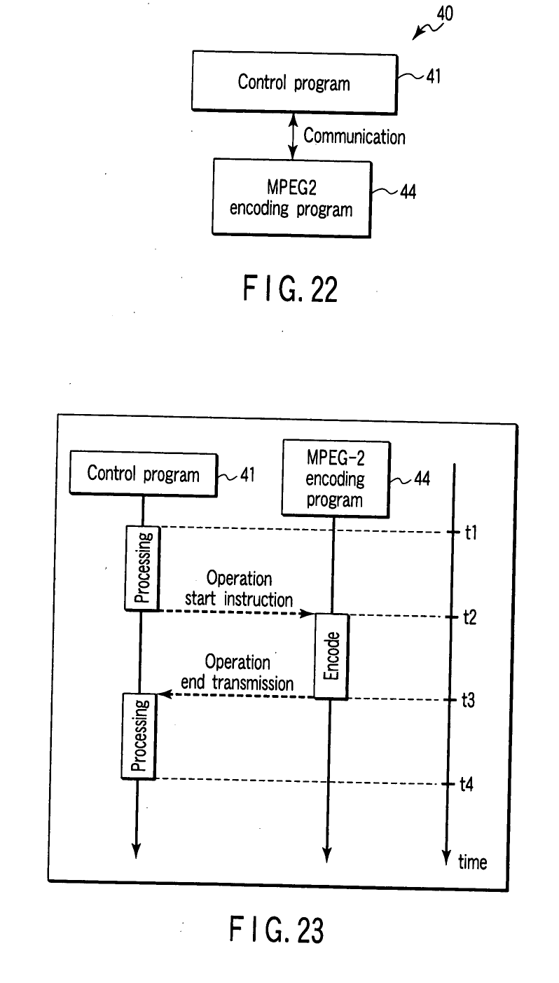

FIG. 22 shows the configuration of a program used to implement the conversion system. FIG. 22 is a conceptual diagram showing the configuration of a program that converts frame image data into the MPEG-2 format. As shown in the figure, the program 40 contains the control program 41 and an MPEG-2 encoding program 44. As is the case with the first embodiment, the control program 41 on MPU 11. The MPEG-2 encoding program 44 operates on one or more VPUs 12. The MPEG-2 encoding program 44 compressively encodes frame picture data into the MPEG-2 format.

FIG. 23 is a timing chart showing the flow of processing executed by the control program 41 and the MPEG-2 encoding program 44. In the figure, time flows from the top to bottom of the sheet of the drawing.

First, at a time t1, for example, MPU 11 executes the control program 41. On the basis of the control program 41, MPU 11 reads frame image data from the I/O control device 15 via the connection device 13. MPU 11 then divides the read frame image data into frames of data and then stores the frames in the main memory 14.

Then, at a time t2, MPU 11 instructs the MPEG-2 encoding program 44 to be executed, on the basis of the control program 41. The MPEG-2 encoding program 44 is executed by, for example, each VPU 12. Then, on the basis of the MPEG-2 encoding program 44, the memory controller 33 in VPU 12 reads data from the main memory 14 into the local storage 32 by DMA. Then, the processing unit 31 encodes the data read into the local storage 32 and stores encoding results in the local storage 32. Subsequently, the memory controller 33 transfers the encoding results from the local storage 32 to the main memory 14 by DMA. The end of the data encoding allows the MPEG-2 encoding program 44 to transmit information indicating that encoding has been finished, to the control program 42.

In this case, the memory capacity of the local storage 32 is smaller than the data size of one frame. Consequently, the frame image data is partly read from the main memory 14 into the local storage 32. The image encoding results are partly transferred from the local storage 32 to the main memory 14. This process is repeated to encode one frame of data.

At a time t3, MPU 11 receives the information indicating that encoding has been finished, from the MPEG-2 encoding program 44. MPU 11 then outputs the encoding results from the main memory 14 to the I/O device 16 via the I/O control device 15, on the basis of the control program 41.

The configuration of frame image data read from the main memory 14 by the MPEG-2 encoding program 44 is similar to that shown in FIG. 4, described in the first embodiment. That is, one frame is drawn using sets each of (S×T) pixels. The luminance components Y and V in one frame are as shown in FIGS. 5 to 7, described in the first embodiment. The macro block MB is also as shown in FIGS. 8 to 12, described in the first embodiment. The description of these elements is thus omitted.

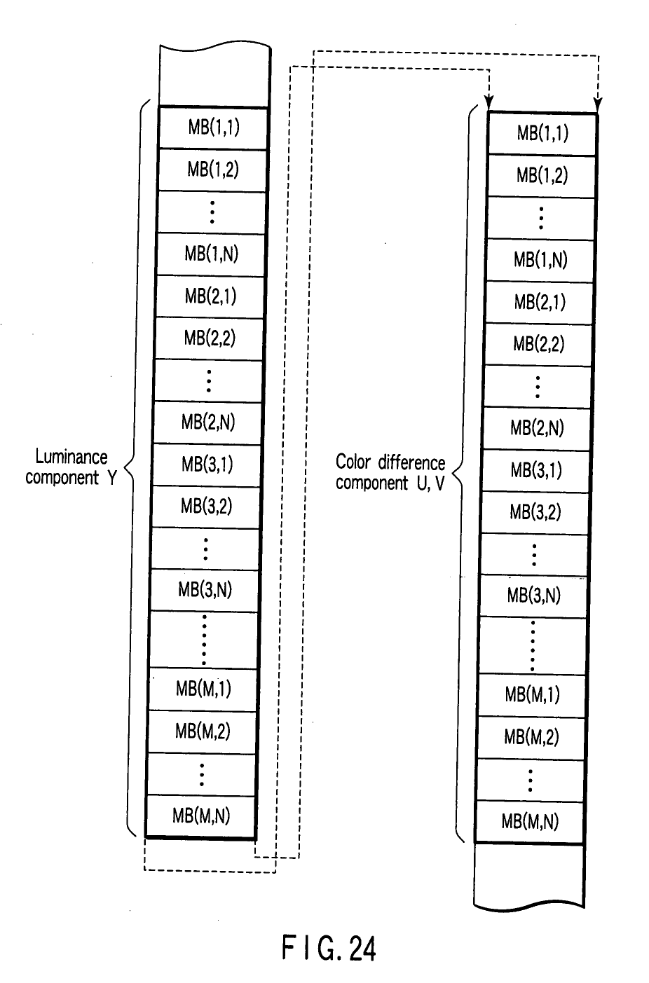

Now, with reference to FIG. 24, description will be given of a method for storing, in the main memory 14, frame image data input by the I/O control device 15 via the connection device 13. FIG. 24 is a schematic diagram of memory spaces in the main memory 14, showing how VPU 12 stores frame image data in the main memory 14.

As shown in the figure, the luminance components Y in each macro block MB are collectively arranged in the main memory 14 at consecutive addresses and followed by the color difference components U and V collectively arranged at consecutive addresses as is the case with the first embodiment.

The luminance components Y and the color difference components U and V are sequentially stored in the main memory 14 in the horizontal direction starting from the macro block MB (1, 1), located at the leftmost uppermost position of the frame. Once the components are stored up to the rightmost macro block (1, N), the remaining components are stored in the macro block MB (2, 1) adjacent to the macro block MB (1, 1) in the vertical direction. That is, the components are sequentially stored in the main memory 14 from the macro block MB (1, 1) to the macro block MB (1, N), then in the main memory 14 from the macro block MB (2, 1) to the macro block MB (2, N), and finally in the main memory 14 from the macro block MB (M, 1) to the macro block MB (M, N).

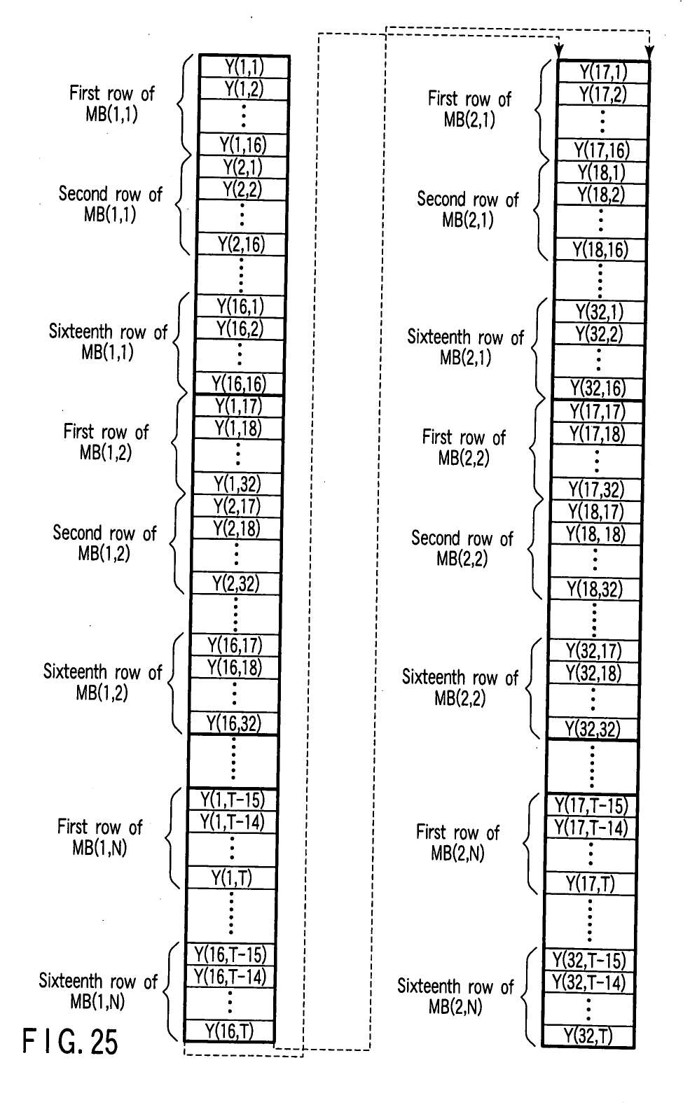

With reference to FIG. 25, description will be given of the arrangement, in the main memory 14, of the luminance components Y contained in each macro block MB. FIG. 25 is a schematic diagram of memory spaces in the main memory 14 showing an area in which the luminance components Y of the macro blocks MB (1, 1) to MB (1, N) and MB (2, 1) to MB (2, N) are stored.

As shown in the figure, the luminance components Y (1, 1) to Y (1, 16) of the pixels in the first row in the macro block MB (1, 1) are first stored. The luminance components Y (2, 1) to Y (2, 16) of the pixels in the second row in the macro block MB (1, 1) are subsequently stored. The luminance components Y in the third to sixteenth rows are subsequently stored.

The luminance components Y (1, 17) to Y (1, 32) of the pixels in the first row in the macro block MB (1, 2) are then stored. The luminance components Y in the second to sixteenth rows are subsequently stored.

The luminance components Y of the macro blocks MB (1, 1) to MB (1, N) are thus sequentially stored in the main memory 14. Then, the luminance components Y (17, 1) to Y (17, 16) of the pixels in the first row in the macro block MB (2, 1) are thus sequentially stored. The macro blocks MB (2, 2) to MB (2, N), having the same coordinate on the axis of ordinate as that of the macro block MB (2, 1), are then sequentially stored.

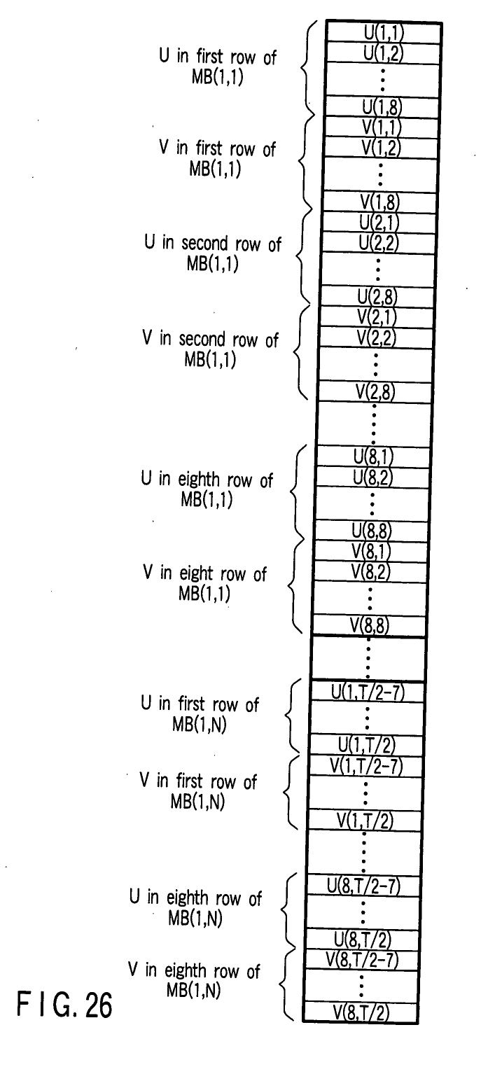

Now, with reference to FIG. 26, description will be given of the arrangement, in the main memory 14, of the color difference components U and V contained in each macro block MB. FIG. 26 is a schematic diagram of memory spaces in the main memory 14 showing an area in which the color difference components U and V of the macro blocks MB (1, 1) to MB (1, N) are stored.

As shown in the figure, the color difference components U (1, 1) to U (1, 8) of the pixels in the first row in the macro block MB (1, 1) are first sequentially stored. The color difference components V (1, 1) to V (1, 8) are then sequentially stored. The color difference components U (2, 1) to U (2, 8) of the pixels in the second row in the macro block MB (1, 1) are subsequently stored. The color difference components V (2, 1) to V (2, 8) are then stored. The luminance components U and V in the third to eight rows are subsequently stored. After the color difference components U and V of the macro block MB (1, 1), the color difference components U and V of the macro blocks MB (1, 2) to MB (1, N) are sequentially stored in the main memory 14.

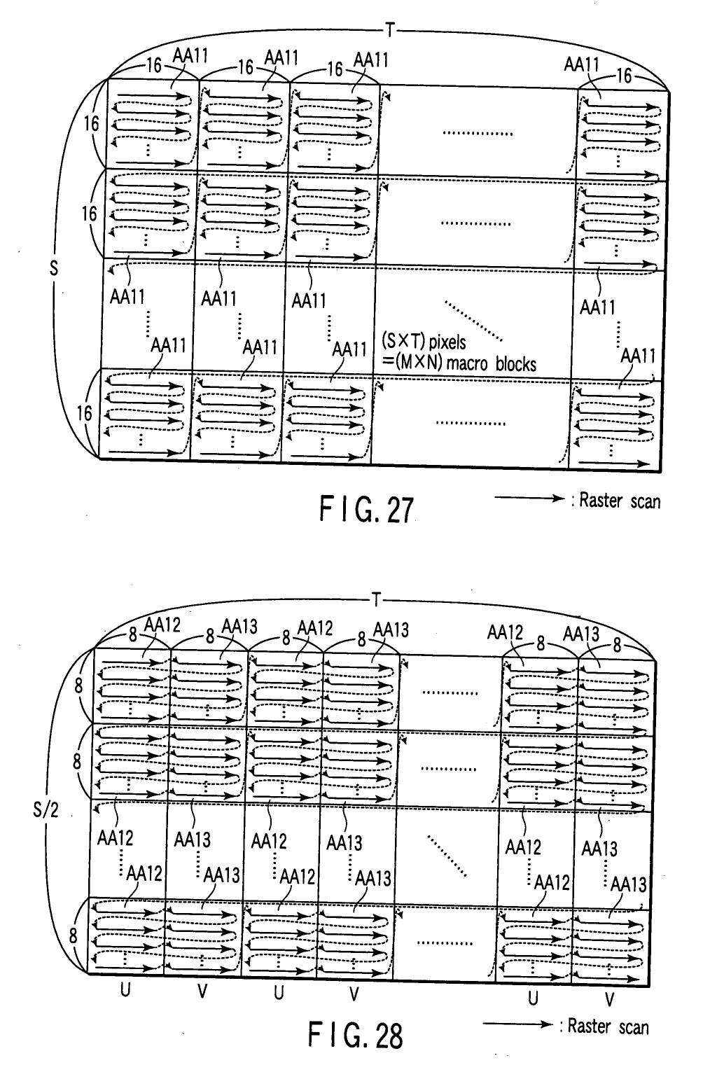

The above data memory arrangement will be described below on the basis of the arrangement of the luminance components in a frame. FIG. 27 is a schematic diagram of one frame specifically showing the luminance components Y. As shown in the figure, the frame is divided into a plurality of 16-byte rectangular areas AA11 having the same horizontal and vertical sizes as those of the macro block MB. In each area AA11, the luminance components are sequentially stored in the main memory 14 in the horizontal direction. That is, the luminance components are sequentially stored in the main memory 14 in the horizontal direction starting from the uppermost leftmost area in area AA11. Once the storage of the luminance components reaches the end of that area, the luminance components in the next row are similarly stored in the main memory. All the luminance components in area AA11 are thus stored in the main memory 14. Then, the luminance components in the adjacent AA11 in the horizontal direction are similarly stored in the main memory 14.

Once the luminance components Y in areas AA11 in the same row are all stored in the main memory 14, the luminance components Y in adjacent area AA11 in the vertical direction are sequentially stored in the main memory 14 from left to right. That is, the luminance components Y in areas AA11 in the second row in the frame are stored in the main memory 14.

The luminance components Y in areas AA11 in the third and subsequent rows are similarly stored in the main memory 14.

FIG. 28 shows the luminance components U and V. As shown in the figure, the frame is divided into a plurality of 8-byte rectangular areas AA12 (for the color difference components U) and a plurality of 8-byte rectangular areas AA13 (for the color difference components V) both having the same horizontal and vertical sizes as those of the macro block. In each of areas AA12 and AA13, the color difference components U and V are sequentially stored in the main memory 14 in the horizontal direction. That is, the color difference components U are sequentially stored in the main memory 14 rightward starting from the uppermost leftmost area in area AA12. Once the storage of the color difference components U reaches the end of area AA12, the color difference components V in area AA13 are stored in the main memory 14 starting with the uppermost leftmost component V. Once the storage of the color difference components V is finished up to the end of area AA13, the color difference components U and V in the next rows are similarly stored in the main memory 14. All the color difference components U and V in areas AA12 and AA13 are thus stored in the main memory 14. Then, the color difference components U and V in adjacent areas AA12 and AA13 in the horizontal direction are similarly stored in the main memory 14.

Once the color difference components U and V in the rightmost areas AA12 and AA13 in the frame are all stored in the main memory 14, the color difference components U and V in areas AA12 and AA13 in the second row are stored in the main memory 14 as described above.

Subsequently, each VPU 12 executes an MPEG-2 format encoding process on the basis of the MPEG-2 encoding program 44. That is, the image data stored so as to separate the luminance components from the color difference components is read from the main memory 14 and encoded into the MPEG-2 format. The memory controller 33 then stores the encoding results provided by the processing unit 31 in the main memory 14.

As described above, the computer system in accordance with the second embodiment of the present invention exerts effects similar to those of the first embodiment. The configuration in accordance with the present embodiment stores the luminance components Y from a frame image in the main memory 14 in macro block units in the order along the horizontal direction of the frame image. That is, 256 byte-data on the luminance components Y in one macro block are arranged in the main memory 14 at consecutive addresses. This also applies to the color difference components U and V. That is, the luminance components U and V in a frame image are stored in the main memory 14 in macro block units in the order along the horizontal direction of the frame image. That is, the 64-byte color difference components U and 64-byte color difference components V in one macro block are arranged in the main memory 14 at consecutive addresses. More specifically, 8 bytes of color difference components U and 8 bytes of color difference components V are alternately arranged in the main memory 14. In this case, the color difference components U of the pixels are stored which are arranged horizontally in one row and which start with the uppermost leftmost pixel. The color difference components V of the same pixels are subsequently stored. Thus, the color difference components U and V are stored from the uppermost row to the lowermost row in the macro block. Also for macro block units, the macro blocks are sequentially stored horizontally in the main memory 14 starting with the uppermost left most macro block in the frame image and from the uppermost row to the lowermost row. This improves the efficiency of DMA transfer of the components in one macro block from the main memory 14 to the local storage 32. This effect has been described in the first embodiment in detail.

The first and second embodiments are effective on processing for, for example, motion estimation. Motion estimation relates to data compression executed on two consecutive frames. That is, two consecutive frames are subjected to delta analysis to determine whether or not any area has changed between the frames and how that area has moved. If a certain image area is the same as that in the preceding frame, the image area may be displayed in the same manner as that for the preceding frame. If the image area has moved in any direction, the image to be displayed is the same as that in the preceding frame and may be moved in the particular direction by a certain amount. This is achieved by VPU 11 by generating a motion vector (MV). Thus determining the motion vector enables a sharp reduction in redundant data.

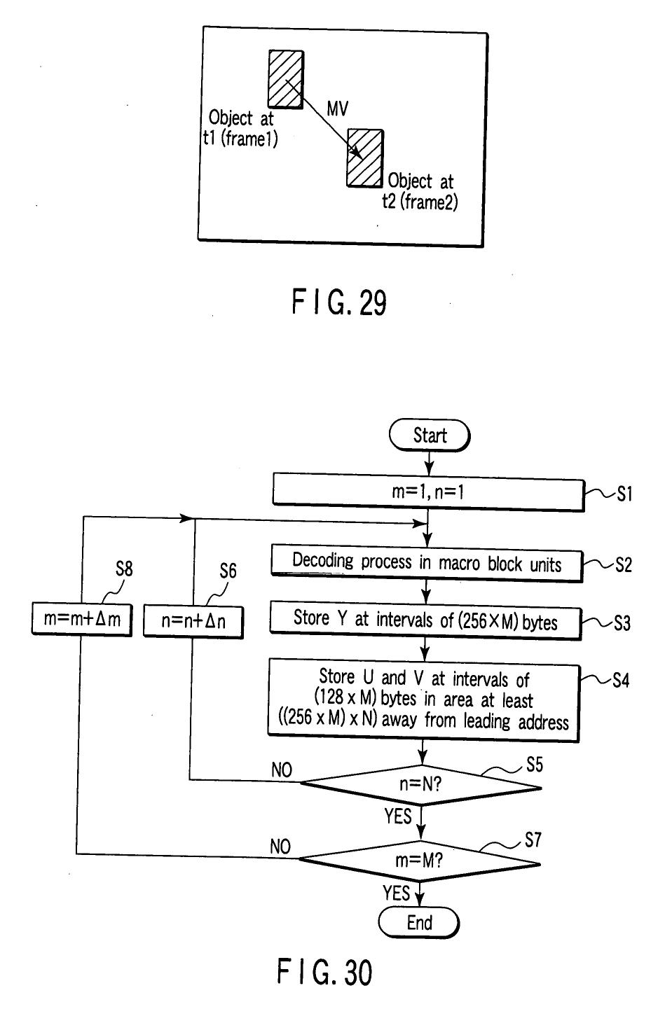

To perform motion estimation, VPU 11 performs template matching between the current frame and a frame temporally closer to the current frame (for example, the frame preceding the current frame, the frame preceding the frame preceding the current frame, or the frame succeeding the frame succeeding the current frame) in macro block units. FIG. 29 shows how an object moves between two frames. For example, it is assumed that at a time t2 (frame 2), an object displayed at a time t1 (frame 1) moves as shown by an illustrated motion vector MV. To generate the motion vector MV, it is necessary to read the macro block MB at the preceding time from the main memory 13. In this regard, the first and second embodiments can efficiently read data from the macro block MB, allowing processing for motion compensation to be efficiently executed.

Further, both MPEG-2 and H.264 utilize macro blocks of 16 pixels×16 pixels. Consequently, the use of the first or second embodiment does not significantly increase the amount of calculation required.

Moreover, according to the first and second embodiments, the luminance components Y and the color difference components U and V are stored horizontally in the main memory 14 at consecutive addresses in 16-pixel units as shown in FIGS. 16, 17, 27, and 28. That is, 16 pixels of the luminance components Y and 16 pixels of the color difference components U and V are stored in the main memory 14 in the horizontal direction and followed by 16 pixels of the luminance components Y adjacent to the above 16 pixels of the luminance components Y in the vertical direction and arranged in the horizontal direction and 16 pixels of the color difference components U and V adjacent to the above 16 pixels of the color difference components U and V in the vertical direction and arranged in the horizontal direction, respectively. Thus, the components are stored horizontally in the main memory 14 at consecutive addresses in 16 pixel units, which are the same as the horizontal width of the macro block MB. However, this is only because of the use of MPEG-2 and H.264 and the above embodiments are not limited to this size. That is, the size of the macro block varies depending on the video encoding scheme. Consequently, the above embodiments do not limit the number of pixels stored in the main memory 14 so that the luminance components and color difference components are consecutively arranged in the horizontal direction to 16. The optimum pixel count can be set depending on the video encoding scheme.

Moreover, according to the first and second embodiments, 8 pixels of the color difference components U are coupled to 8 pixels of the color difference components V. These 16 pixels consecutively arranged in the frame in the horizontal direction are stored in the main memory 14 at consecutive addresses. This is because both MPEG-2 and H.264 utilizes a Y:U:V=4:2:0 format as an I/O data format. However, the pixel data format is not limited to Y:U:V=4:2:0. For example, it is possible to hold video data of a Y:U:V=4:4:4 format in which the color difference components U and V have a horizontal width and a vertical width that are double those of the color difference components U and V in the Y:U:V=4:2:0 format. In this case, pixel data can be efficiently accessed by holding both the color difference components U and V in the same format as that of the luminance components Y. Further, if an RGB format is utilized in which all the components have an equal vertical width and an equal horizontal width and in which video data is expressed by red components R, green components G, and blue components B, pixel data can be efficiently accessed by storing the components in the same format as that of the luminance components Y.

Further, the first and second embodiments have been described taking the case of MPEG-2 decoding, MPEG-2 encoding, and H.264 encoding. However, the compressive encoding format is not particularly limited. The first and second embodiments are applicable to compressive encoding formats in general with which images are processed on the basis of certain sets of pixels (the images are read from the memory).

Moreover, in the description of the example in the first embodiment, data in the MPEG-2 format is decoded and then encoded into the H.264 format. However, the first and second embodiments are of course applicable to the process of only decoding data in the MPEG-2 format or encoding data into the H.264 format. That is, the above embodiments are commonly applicable to the case where non-encoded data is stored in the main memory 14 for image processing.

Furthermore, in the description of the examples in the first and second embodiments, data is stored in the main memory 14 at consecutive addresses in macro block units used for image encoding and decoding. However, the macro block is only an example of the unit and any processing unit can be used provided that it is used for image processing. For example, it is possible to use a unit used for deblocking filter or a deringing filter for image data into which data in the MPEG-2 format has been decoded. The deblocking filter will be described below. Pixel information for different macro blocks is not taken into account for the compression scheme. Accordingly, a pixel luminance artifact may occur between adjacent blocks. This is usually called block noise. Thus, the deblocking filter removes the block noise by executing a filtering process using a plurality of pixel groups adjacent to each other across the boundary between adjacent macro blocks. In this case, the pixel groups used for the filtering process may be replaced with the macro blocks. Further, images may undergo ringing noise caused by high-frequency components. In this case, a plurality of pixel groups containing an area in which noise has occurred are filtered to smooth images. This is a deringing filter. Accordingly, the macro blocks may be replaced with the pixel groups used for the filtering process executed by the deringing filter. Furthermore, the first and second embodiments are not limited to the case of image encoding and decoding but are applicable to image processing in general which uses processing units including a plurality of pixels. Further, the image data input to or output by the computer systems in accordance with the first and second embodiments may be non-encoded.

If videos stored in the main memory are reproduced through the output device by the method in accordance with the first or second embodiment, the data is desirably rearranged as shown in FIG. 18. This process may be executed by a device newly provided in the computer system 10, VPU 11, or the output device.

The first embodiment not only separates frame into rectangular areas with the same width as that of the macro block but also stores the luminous components Y in the main memory 14 separately from the color difference components U and V as shown in FIG. 13. The second embodiment separates the frame into areas of the same size as that of the macro block and stores the luminous components Y in the main memory 14 separately from the color difference components U and V as shown in FIG. 24. That is, the luminance components Y for all the macro blocks are first stored in the main memory 14, and the color difference components U and V are stored in an area different from the area in which the luminance components Y are stored. In normal image processing, only the luminance components Y are often used and not the color difference components U and V. Accordingly, data transfer can be more efficiently performed by completely separating the luminance components Y from the color difference components U and V without mixing them together. If the frame is separated into rectangular areas and the luminance components Y and the color difference components U and Y are mixedly stored in the main memory, reading the macro block shown in FIG. 21 requires four data transfers for areas A, B, C, and D. Consequently, the leading addresses of areas A, B, C, and D must be calculated, requiring double the amount of data transfer and address calculation compared to the method in accordance with the first or second embodiment.

With reference to FIG. 30, description will be given of a process for separating the luminance components Y from the color difference components U and V. FIG. 30 is a flowchart showing a decoding and data transfer method executed by the MPEG-2 decoding program 42. The flowchart also applies to the case of H.264. FIG. 30 is useful for implementing the storage method described in the first embodiment.

As shown in the figure, first, m is set at 1 and n is set at 1 (step S1). That is, the macro block MB (1, 1) is selected. Each VPU 12 executes a decoding process in macro block units (step S2). The memory controller 33 transfers the luminance components Y to the main memory 14 by DMA to store the luminance components Y in the main memory 14 (step S3). The memory controller 33 further transfers the color difference components U and V to the main memory 14 by DMA (step S4). If n has not reached N (step S5, NO), that is, the macro block positioned at the right end of the frame has not completely been decoded, n is set at n+Δn (step S6). The processing in steps S2 to S4 is repeated on the rightward adjacent macro block.

If n=N (step S5, YES), the memory controller 33 determines whether or not m has reached M. If m has not reached M (step S7, NO), that is, the macro block positioned at the lower end of the frame has not completely been decoded, m is set at m+Δm (step S8). The processing in steps S2 to S6 is repeated on the downward adjacent macro block.

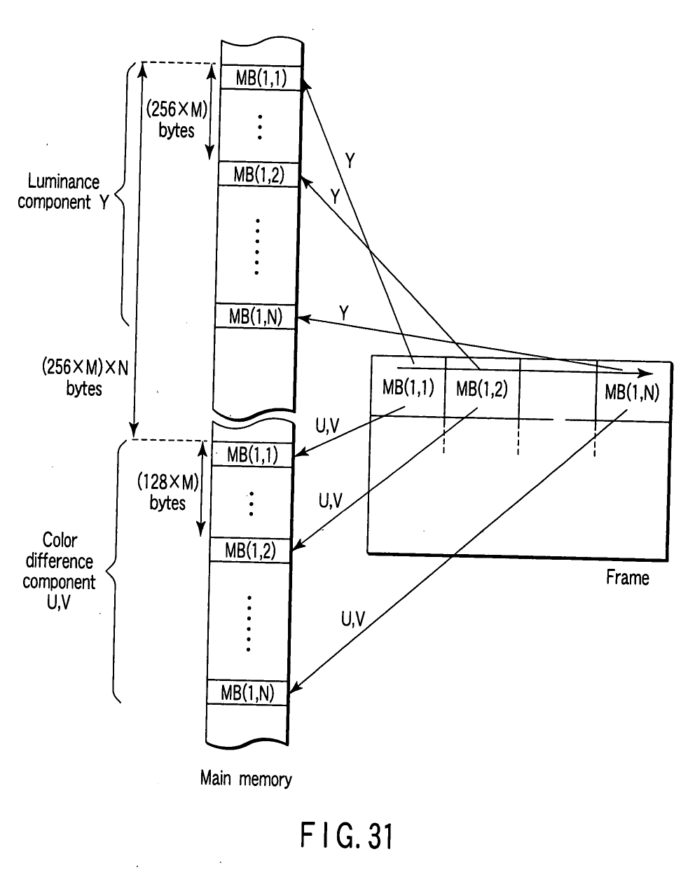

When macro blocks in the same row are stored in the main memory 14 in step S3, if the size of each macro block is 256 bytes, the luminance components Y are stored at intervals of (256×M) bytes. Further, when macro blocks in the same row are stored in the main memory 14 in step S4, the color difference components U and V are stored in an area at least (256×M)×N bytes away from the leading address of the area in which the luminance components Y of the macro block MB (1, 1) are stored. This is first shown in FIG. 31. FIG. 31 is a schematic diagram showing memory spaces in the main memory 14 and a frame, in which macro block MB (1, 1) to MB (1, N) where m=1 and n=1 to N are stored in the main memory 14.

As shown in the figure, the luminance components of the macro blocks MB (1, 1), MB (1, 2), . . . MB (1, N) are stored in the main memory 14 at intervals of (256×M) bytes. The color difference components U and V of the macro block MB (1, 1) are stored in an area ((256×M)×N) bytes away from the leading address of the luminance components Y of the macro block MB (1, 1). The color difference components U and Y are stored at intervals of (128×M) bytes.

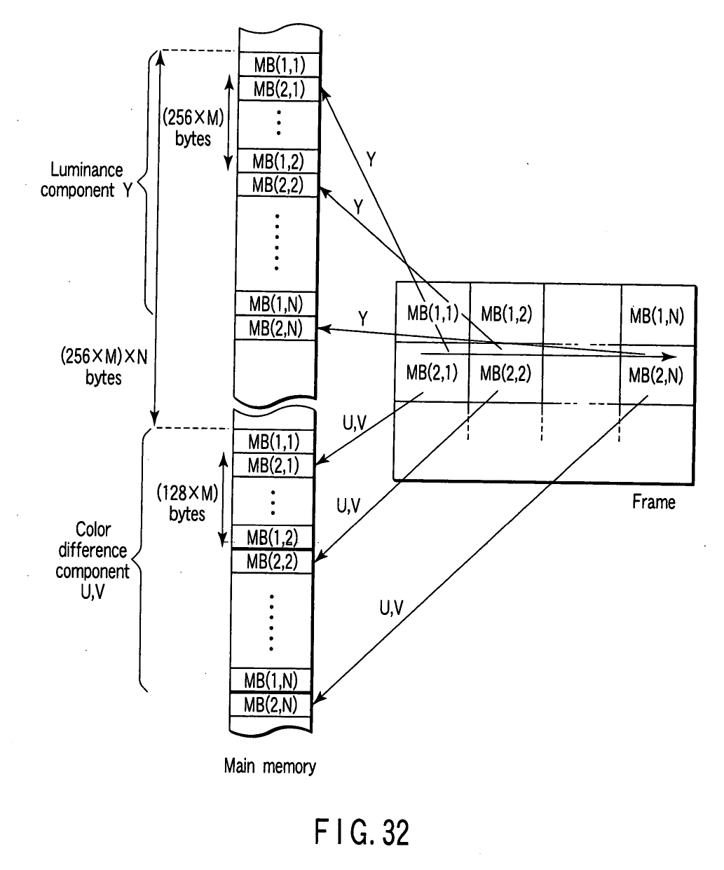

FIG. 32 is a schematic diagram showing memory spaces in the main memory 14 and a frame, in which macro block MB (2, 1) to MB (2, N) where m=2 and n=1 to N are stored in the main memory 14. As shown in the figure, the luminance components of the macro block MB (2, 1) are stored in the main memory 14 so that the addresses of the luminance components are consecutive with the area in which the macro block MB (1, 1) is stored. The luminance components Y of the macro blocks MB (2, 1), MB (2, 2), . . . MB (2, N) are stored in the main memory 14 at intervals of (256×M) bytes. The color difference components U and V of the macro block MB (2, 1) are stored in the main memory 14 so that the addresses of the color difference components are consecutive with the area in which the color difference components U and V of the macro block MB (1, 1) is stored. That is, the color difference components U and V of the macro block MB (2, 1) are stored in an area ((256×M)×N) bytes away from the leading address of the luminance components Y of the macro block MB (2, 1).

Storing the components in the main memory 14 as described above enables such data arrangement as shown in FIG. 13. To implement the data arrangement shown in FIG. 24, in each of steps S3 and S4 in the flowchart in FIG. 30, the luminance components Y and the color difference components U and V may be stored at consecutive addresses instead of being stored at intervals of (256×M) bytes.

As described above, the first and second embodiments of the present invention use a method for storing image data for video frames divided into pieces in the vertical direction, in a video processing system using a processor system which has a plurality of processor cores sharing a main memory and which limits the size of data transferred between the main memory and a local storage area. Alternatively, the first and second embodiments of the present invention use a method for storing video data divided into rectangular areas of a certain predetermined size.

That is, the processor system 10 in accordance with the above embodiments includes MPU 11, VPU 12, and the main memory 14. VPU 12 executes image processing on first image data to generate second image data. The image processing is, for example, an image encoding process or decoding process. VPU 12 executes image processing on the first image data in macro block units that are a set of a plurality of pixels. MPU 11 controls the operation of a plurality of VPUs 12.

If first image data is encoded image data, VPU 12 decodes the first image data to generate second image data that is a frame image. The main memory 14 holds the second image data. In this case, the main memory 14 stores the luminance components Y in a first memory space with consecutive addresses and stores the luminance components Y contained in the same macro block of the second image data, at consecutive addresses in the first memory space (see FIGS. 13 and 14).

In this case, according to the first embodiment, the second image data is a frame image containing a plurality of rectangular areas AA1 (see FIG. 16) arranged in the horizontal direction and having a horizontal width equal to that of the macro block. The main memory 14 consecutively holds the luminance components Y of the pixels contained in the second image data, in the first memory space of the main memory 14 in rectangular area AA1 units in the order along the horizontal direction of the frame image. The main memory 14 consecutively holds the luminance components Y of the pixels in each rectangular area AA1, in the order along the horizontal direction of each rectangular area AA11 (see FIG. 16).

With the method in accordance with the second embodiment, the second image data is a frame image containing a plurality of rectangular images AA11 (see FIG. 27) arranged in a matrix and having a vertical size and a horizontal size equal to those of the macro block. The main memory 14 consecutively holds the luminance components Y of the pixels contained in the second image data, in the first memory space in rectangular area AA11 units in the order along the horizontal direction of the frame image. The main memory 14 consecutively holds the luminance components Y of the pixels in each rectangular area AA11, in the order along the horizontal direction of each rectangular area AA11 (see FIG. 27).

If the first image data is non-encoded frame image data, VPU 12 encodes the first image data to generate second image data. The main memory 14 holds the first image data. In this case, the main memory 14 holds the luminance components Y in the first memory space with consecutive addresses and holds the luminance components Y contained in the same macro block of the first image data, at consecutive addresses in the first memory space (see FIGS. 13 and 14). Then, according to each of the first and second embodiments, the luminance components Y are stored in the main memory 14 by the method described with reference to FIGS. 16 and 27.

Moreover, the main memory 14 holds the color difference components of the frame image data in the second memory space with consecutive addresses. The second memory space is an area different from the first memory space (see FIGS. 13 and 24). The color difference components include the first color difference components U and second color difference components V each assigned to every four pixels. The main memory 14 holds the first and second color difference components U and V contained in the same macro block, in the second memory space at consecutive addresses (see FIGS. 15 and 26).

This enables a reduction in the amount of data transferred between the main memory and the local storage area as well as the number of transfers required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A processor system comprising:
a plurality of first processors which execute image processing on first image data to generate second image data, each of the first processors executing the image processing in pixel group units each of which is a set of a plurality of pixels contained in the first image data;
a second processor which controls an operation of the first processors; and
a memory device which holds at least one of the first image data and the second image data, the memory device holding luminance components of at least one of the first image data and the second image data in a first memory space with consecutive addresses and holding the luminance components contained in the same pixel group, in the first memory space at the consecutive addresses.

2. The system according to claim 1, wherein the first image data is encoded image data,
the first processors decode the first image data read from the memory device to generate the second image data and allows the memory device to hold the second image data, and
the memory device holds the luminance components of the second image data in the first memory space with consecutive addresses, and holds the luminance components contained in the same pixel group in the second image data, in the first memory space at consecutive addresses.

3. The system according to claim 2, wherein the second image data is a frame image having a plurality of rectangular areas arranged in a horizontal direction, each of the rectangular areas being a set of a plurality of pixels and having a horizontal width equal to that of the pixel group, and
the memory device consecutively holds the luminance components of the pixels contained in the second image data, in the first memory space in the rectangular area units in an order along the horizontal direction in the frame image, and
consecutively holds the luminance components of the pixels in each of the rectangular areas, in the order of the horizontal direction of each of the rectangular areas.

4. The system according to claim 2, wherein the second image data is a frame image having a plurality of rectangular areas arranged in a matrix, each of the rectangular areas being a set of a plurality of pixels and having a vertical size and a horizontal size which are equal to those of the pixel group, and
the memory device consecutively holds the luminance components of the pixels contained in the second image data, in the first memory space in the rectangular area units in an order along a horizontal direction in the frame image, and
consecutively holds the luminance components of the pixels in each of the rectangular areas, in the order of the horizontal direction of each of the rectangular areas.

5. The system according to claim 1, wherein the first image data is non-encoded image data and is held in the memory device,
the first processors decode the first image data read from the memory device to generate the second image data, and
the memory device holds the luminance components of the first image data in the first memory space with consecutive addresses, and holds the luminance components contained in the same pixel group in the first image data, in the first memory space at consecutive addresses.

6. The system according to claim 5, wherein the first image data is a frame image having a plurality of rectangular areas arranged in a horizontal direction, each of the rectangular areas being a set of a plurality of pixels and having a horizontal width equal to that of the pixel group, and
the memory device consecutively holds the luminance components of the pixels contained in the first image data, in the first memory space in the rectangular area units in an order along the horizontal direction in the frame image, and
consecutively holds the luminance components of the pixels in each of the rectangular areas, in the order of the horizontal direction of each of the rectangular areas.

7. The system according to claim 5, wherein the first image data is a frame image having a plurality of rectangular areas arranged in a matrix, each of the rectangular areas being a set of a plurality of pixels and having a vertical size and a horizontal size which are equal to those of the pixel group, and
the memory device consecutively holds the luminance components of the pixels contained in the first image data, in the first memory space in the rectangular area units in an order along the horizontal direction in the frame image, and
consecutively holds the luminance components of the pixels in each of the rectangular areas, in the order of the horizontal direction of each of the rectangular areas.

8. The system according to claim 1, wherein the memory device holds color difference components of said at least one of the first image data and the second image data in a second memory space with consecutive addresses, and
the second memory space is an area different from the first memory space.

9. The system according to claim 8, wherein the color difference components include first color difference components and second color difference components each assigned to every plurality of the pixels, and
the memory device holds the first and second color difference components contained in the same pixel group, in the second memory space at consecutive addresses.

10. The system according to claim 1, wherein the first processor includes a local memory device configured to hold at least one of the first and second image data;
a transfer device which transfers at least one of the first and second image data between the memory device and the local memory device by direct memory access; and
a control section which executes the image processing using at least one of the first and second image data transferred to the local memory device.

11. The system according to claim 10, wherein the transfer device transfers at least one of the first and second image data in accordance with a data size which is smaller than the pixel group unit.

12. A data transfer method for a processor system including a main memory which holds image data containing a plurality of pixel groups each of which is a set of a plurality of pixels, a plurality of first processors each including a local memory, and a second processor which controls operations of a plurality of the first processors, the method comprising:
transferring luminance components obtained by the first processors by decoding the image data in the pixel group units, from the local memory to the main memory;
transferring color difference components obtained by the first processors by decoding the image data in the pixel group units, from the local memory to the main memory so that the color difference components are stored in an area of the main memory which is separate from an area of the main memory in which the luminance components are stored, the luminance components of the image data being held in the main memory at consecutive addresses, the luminance components contained in each of the pixel groups being held in the main memory at consecutive addresses.
